(19) United States
(12) Patent Application Publication
(10) Pub. No.: US 2023/0297746 A1
(43) Pub. Date: Sep. 21, 2023

(54) LAYOUT DESIGN TOOL

(71) Applicant: Samsung Electronics Co., Ltd., Suwon-si (KR)

(72) Inventors: Wangi SOHN, Hwaseong-si (KR); Dongjin PARK, Suwon-si (KR); Sunghyun BAE, Hwaseong-si (KR); Junyoung JANG, Suwon-si (KR)

(73) Assignee: Samsung Electronics Co., Ltd., Suwon-si (KR)

(21) Appl. No.: 18/184,902

(22) Filed: Mar. 16, 2023

(30) Foreign Application Priority Data
Mar. 18, 2022 (KR) 10-2022-0033739

(51) Int. Cl. G06F 30/31; G06F 30/392

(52) U.S. Cl. CPC G06F 30/31; G06F 30/392

(57) ABSTRACT

A layout design tool for generating a layout graphic based on a first input and a modification input includes a processing circuitry that generates a temporary layout in which a pattern is scripted based on the first input, and modifies the temporary layout based on the modification input to generate the layout graphic, and the processing circuitry designates a plurality of modification regions to be modified on the temporary layout based on the modification input and designates a plurality of transform regions on a background layer, the plurality of modification regions of the temporary layout, and the layout design tool generates a pattern layer by extracting the pattern group included in any one of the plurality of modification regions and generates the layout graphic by placing the pattern layer on the plurality of transform regions of the background layer.

### CROSS-REFERENCE TO RELATED APPLICATIONS

This application claims priority under 35 U.S.C. § 119 to Korean Patent Application No. 10-2022-0033739, filed on Mar. 18, 2022, in the Korean Intellectual Property Office, the disclosures of which are incorporated by reference herein in their entireties.

### BACKGROUND

Various example embodiments relate to a semiconductor design system, and more particularly, relate to a layout design tool.

Semiconductor devices are fabricated by patterning devices and their interconnections on a substrate, such as a semiconductor wafer. As an example, the semiconductor device may be designed and/or fabricated through an electronic design automation (EDA) tool. The EDA enables integrated circuits to be designed by allowing layout designers to position and connect various components of a circuit to work together. Layout designers may generate a layout of a semiconductor device using the electronic design automation.

The layout of a semiconductor device includes circuit components, connecting wirings, and physical positions, along with sizes of various layers. By verifying the layout of such semiconductor devices and transferring it on a semiconductor substrate, the semiconductor devices may be fabricated.

### SUMMARY

Various example embodiments provide a layout modifying module that performs a modification on modification regions including the same pattern groups, with low or lower computational use.

Alternatively or additionally, various example embodiments provide a layout modification method that performs modification on modification regions including the same pattern groups with low computation.

According to various example embodiments, a layout design tool for generating a layout graphic based on a user input and a modification input, which includes processing circuitry configured to execute machine readable instructions that, when executed by the processing circuitry, cause the processing circuitry to generate a temporary layout in which a pattern is scripted based on the user input, to modify modifies the temporary layout based on the modification input to generate the layout graphic, and to designate a plurality of modification regions to be modified on the temporary layout based on the modification input and designate a plurality of transform regions on a background layer. The plurality of modification regions of the temporary layout include pattern groups having a same shape, and the processing circuitry is configured to generate a pattern layer by extracting the pattern group included in any one of the plurality of modification regions and to generate the layout graphic by placing the pattern layer on the plurality of transform regions of the background layer.

According to various example embodiments, a method of modifying a layout with a layout design tool includes designating a plurality of modification regions which include pattern groups having a same shape to be modified on a temporary layout, generating a pattern layer by extracting the pattern group from any one of the plurality of modification regions, generating a background layer by removing the pattern groups within the plurality of modification regions in the temporary layout, designating transform regions on the background layer, and placing the pattern layer on the transform regions of the background layer to generate a final layout graphic.

According to various example embodiments, a semiconductor fabrication system for fabricating a semiconductor device by generating a layout graphic based on a first input and a modification input, includes a layout design tool that configured to execute machine-readable instructions that, when executed by the layout design tool, cause the layout design tool to generate the layout graphic based on the first input and the modification input, and a semiconductor fabrication device that is configured to fabricate the semiconductor device based on the layout graphic. The layout design tool is configured to generate a temporary layout in which a pattern is scripted based on the first input, and to modify the temporary layout based on the modification input to generate the layout graphic. The layout design tool is configured to designate a plurality of modification regions to be modified on the temporary layout based on the modification input and designates a plurality of transform regions on a background layer, the plurality of modification regions of the temporary layout include pattern groups having a same shape. The layout design tool is configured to generate a pattern layer by extracting the pattern group included in any one of the plurality of modification regions and to generate the layout graphic by placing the pattern layer on the plurality of transform regions of the background layer.

### BRIEF DESCRIPTION OF THE FIGURES

A detailed description of each drawing is provided to facilitate a more thorough understanding of the drawings referenced in the detailed description of the present disclosure.

FIG. 1 is a block diagram illustrating a semiconductor fabrication system, according to various example embodiments.

FIG. 2 is a block diagram illustrating a layout design tool according to the present disclosure.

FIG. 3 is a block diagram illustrating a layout modifying module, according to various example embodiments.

FIGS. 4 and 5 are diagrams illustrating an example of a temporary layout provided to an extracting module 121 in FIG. 3.

FIG. 6 is a flowchart illustrating that an extracting module of FIG. 3 generates a temporary pattern layer by extracting a pattern group from a temporary layout.

FIG. 7 is a diagram for describing an operation of an extracting module corresponding to FIG. 6.

FIG. 8 is a flowchart for describing that an extracting module of FIG. 3 generates a background layer.

FIG. 9 is a diagram for describing an operation of an extracting module corresponding to FIG. 8.

FIG. 10 is a flowchart illustrating that a pattern layer generation module of FIG. 3 generates an extension box and a pattern layer.

FIG. 11 is a diagram for describing an operation of the pattern layer generation module corresponding to FIG. 10.

FIG. 12 is a flowchart for describing that a transform module of FIG. 3 generates a final layout graphic.

FIG. 13 is a diagram for describing an operation of a transform module corresponding to FIG. 12.

FIG. 14 is a block diagram illustrating a layout modifying module, according to various example embodiments.

FIG. 15 is a diagram illustrating an example of a temporary layout provided to an extracting module in FIG. 14.

FIG. 16 is a diagram for describing an operation of generating a pattern layer of an extracting module.

FIG. 17 is a diagram for describing an operation of generating a background layer of an extracting module.

FIG. 18 is a flowchart for describing that a transform module of FIG. 14 generates a final layout graphic.

FIG. 19 is a diagram for describing an operation of a transform module corresponding to FIG. 18.

### DETAILED DESCRIPTION

Below, various example embodiments of the present disclosure may be described in detail and clearly to such an extent that an ordinary one in the art easily implements the present disclosure.

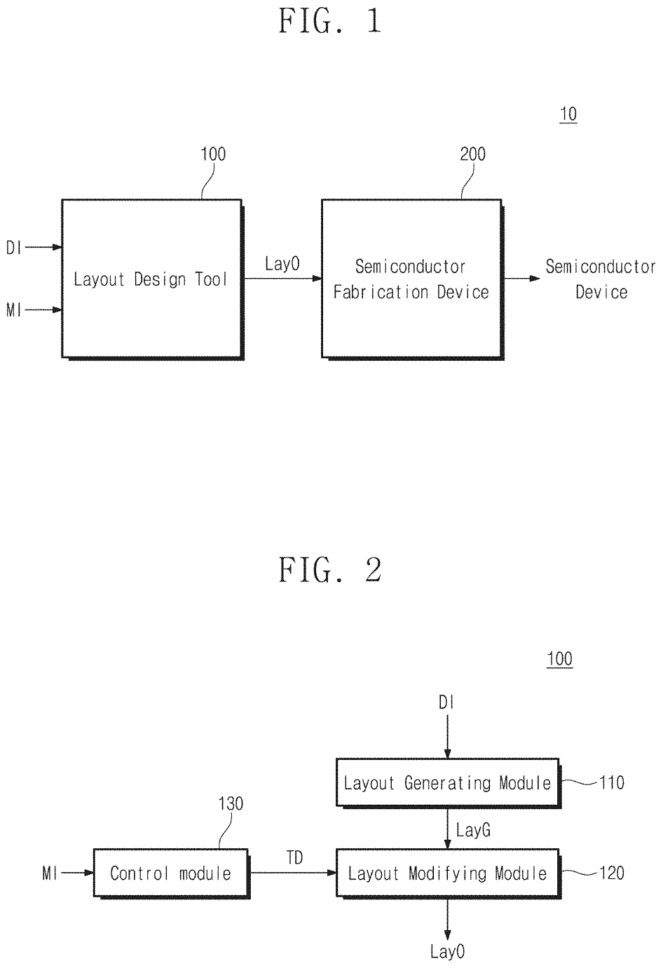

FIG. 1 is a block diagram illustrating a semiconductor fabrication system, according to various example embodiments.

Referring to FIG. 1, a semiconductor fabrication system 10 may include a layout design tool 100 and a semiconductor fabrication device 200. In various example embodiments, the semiconductor fabrication system 10 may fabricate a semiconductor device by designing integrated circuits based on input information DI and MI.

The layout design tool 100 may generate a layout graphic LayO in which the integrated circuits in semiconductor devices are scripted or are to be fabricated. For example, the layout design tool 100 may receive first data, such as user input DI and the modification input MI, and may generate the layout graphic LayO based on the received input information DI and MI.

In various example embodiments, the user input DI may include variables for designing a semiconductor integrated circuit. In various example embodiments, the modification input MI may include variables for modifying a layout. For example, the modification input MI may include variables for performing a coordinate transform of a pattern on a layout. The layout graphic LayO output from the layout design tool 100 may include a plurality of hierarchical layers in which integrated circuits are scripted or to be patterned.

In some example embodiments, the layout design tool 100 may generate the layout graphic LayO by using a computer-aided design (CAD) tool. The layout design tool 100 may be stored in a storage medium in the form of software, or machine-readable instructions, and may be read and/or executed by a computer. The storage medium may include, but is not limited to, for example, one or more of a compact disk, a floppy disk, a random access memory (RAM), and/or a read only memory (ROM).

The layout graphic LayO may include an integrated circuit and/or a pattern for fabricating a semiconductor device constituting the integrated circuit. The pattern may include, for example, shapes corresponding to capacitors, doped regions, gate lines, active areas, contacts, vias, insulating layers, and/or wirings.

The semiconductor fabrication device 200 may receive the layout graphic LayO from the layout design tool 100. The layout design tool 100 may output the layout graphic LayO and may provide it to the semiconductor fabrication device 200. The semiconductor fabrication device 200 may use the received layout graphic LayO to fabricate the semiconductor device including the integrated circuits. In some example embodiments, the semiconductor fabrication device 200 may include a device that manufactures one or more photolithography masks based on the received layout graphic LayO, and/or a device that fabricates and patterns the semiconductor device based on the photolithography masks. Hereinafter, unless otherwise defined among terms used, a layout referred to in an operation of the layout design tool 100 may have the same meaning as a layout graphic.

FIG. 2 is a block diagram illustrating a layout design tool of FIG. 1.

Referring to FIGS. 1 and 2, the layout design tool 100 may include a layout generating module 110, a layout modifying module 120, and a control module 130. In various example embodiments, the layout design tool 100 may generate and output the layout graphic LayO based on the user input DI and the modification input MI. Hereinafter, the layout graphic LayO output from the layout design tool 100 may be referred to as the final layout graphic LayO.

The layout generating module 110 may generate a temporary layout LayG based on the user input DI. The user input DI may include variables for designing a semiconductor integrated circuit. For example, the user input DI may include information on the shape and/or on the position coordinates of a pattern to be formed on the temporary layout LayG. The layout generating module 110 may generate the temporary layout LayG by scripting or positioning the various patterns by determining the shape and/or the position of various patterns based on the user input DI. In various example embodiments, at least some of the various patterns may be scripted in indenting on the temporary layout LayG. Alternatively or additionally, at least some of the various patterns may be scripted in embossing on the temporary layout LayG.

The pattern scripted on the temporary layout LayG may include shapes corresponding to one or more of a capacitor, a via, an active area, a gate wiring, a doped region, a contact, an insulating layer, a wiring, etc. As an example, some of the shapes may be periodically arranged in the pattern on the temporary layout LayG, but example embodiments are not limited thereto.

The temporary layout LayG may include a plurality of layers. The plurality of layers may be provided hierarchically. Any one of the plurality of layers may include a plurality of cell regions. For example, the temporary layout LayG may include first to third cell regions CELL1, CELL2, and CELL3. The first to third cell regions CELL1, CELL2, and CELL3 may be or correspond to regions for forming corresponding semiconductor cells in the semiconductor fabrication device 200. Alternatively or additionally, the temporary layout LayG may include peripheral circuit regions (not illustrated) for forming integrated circuits. The temporary layout LayG generated by the layout generating module 110 may be provided to the layout modifying module 120.

The control module 130 may generate transform information TD based on the modification input MI. The modification input MI may include variables for coordinate transforms of the pattern on the temporary layout LayG. For example, the modification input MI may include variables for moving parallelly or symmetrically some of the patterns on the temporary layout LayG.

According to various example embodiments, the transform information TD may include information on a modification target layer, a modification target cell region, a modification target region, and a coordinate transform region, in a temporary layout. The transform information TD generated by the control module 130 may be provided to the layout modifying module 120.

The layout modifying module 120 may modify the temporary layout LayG based on the transform information TD. For example, the layout modifying module 120 may coordinate-transform some or all of the patterns on the temporary layout LayG. Hereinafter, for convenience of description, the modification of the temporary layout LayG by the layout modifying module 120 based on the transform information TD is referred to as a modification operation and/or a modification operation with respect to the temporary layout LayG.

The modification operation with respect to the temporary layout LayG may include operations of symmetrically moving and/or parallelly moving some of patterns on the temporary layout LayG, e.g. of one or more of translations, rotations, or reflects of some of the patterns. Some patterns having the same shape on the temporary layout LayG may be coordinate-transformed through the modification operation.

The layout modifying module 120 may output the final layout graphic LayO by modifying the temporary layout LayG based on the transform information TD. The final layout graphic LayO generated by the layout modifying module 120 may be provided to the semiconductor fabrication device 200 (refer to FIG. 1). Hereinafter, a detailed configuration and operation of the layout modifying module 120 will be described.

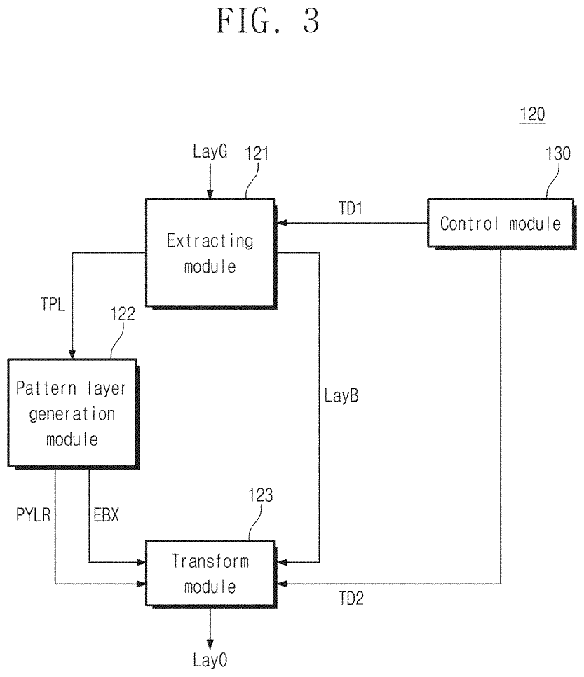

FIG. 3 is a block diagram illustrating an embodiment of a layout modifying module of FIG. 2.

Referring to FIGS. 2 and 3, the layout modifying module 120 may include an extracting module 121, a pattern layer generation module 122, and a transform module 123.

The extracting module 121 may receive the temporary layout LayG and first transform information TD1. The received temporary layout LayG may include a plurality of hierarchical layers. As an example, any one or more of the received plurality of layers may include a pattern, which is scripted in indenting. The first transform information TD1 may include information for designating a modification target layer, a modification target cell region, and a modification target region, in the temporary layout LayG.

The information in the modification target layer may be or may include information for designating a layer to be modified among a plurality of hierarchical layers of the temporary layout LayG. The information on the modification target cell region may be or may include information for designating cell regions to be modified among cell regions included in the modification target layer. The information on the modification target region may be or may include information for designating modification regions to be modified on the modification target cell regions.

For example, the extracting module 121 may designate one layer to be modified among a plurality of hierarchical layers of the temporary layout LayG based on the information on the modification target layer of the first transform information TD1. The extracting module 121 may designate a cell region to be modified among cell regions on a designated layer based on the information on the modification target cell region of the first transform information TD1. The extracting module 121 may designate modification regions to be modified in a designated cell region on a designated layer based on the information on the modification target region of the first transform information TD1.

The modification regions designated based on the first transform information TD1 may include pattern groups having the same shape. The pattern group may refer to a pattern included in the modification regions. Each of the pattern groups may include a plurality of shapes, and shapes constituting or included in the pattern group in each of the modification regions may have the same shape and/or the same arrangement as each other.

The extracting module 121 may perform an extraction operation of extracting a pattern group from any one of the designated modification regions based on the first transform information TD1. The extracting module 121 may generate a temporary pattern layer TPL by using the pattern group extracted through the extraction operation.

In various example embodiments, the temporary pattern layer TPL generated by the extracting module 121 may be or may include a separate layer including the extracted pattern group. As an example, the temporary pattern layer TPL may be or may include a layer in which the pattern group is scripted in embossing.

A size of the temporary pattern layer TPL may be set to be the same as a size of the modification region. As an example, the temporary pattern layer TPL may be set to have the same vertex coordinates as the vertex coordinates of the modification region. The temporary pattern layer TPL generated by the extracting module 121 may be provided to the pattern layer generation module 122.

The extracting module 121 may generate a background layer LayB. The background layer LayB may be or may include a layer from which patterns inside the modification regions are removed in the temporary layout LayG. The background layer LayB generated by the extracting module 121 may be provided to the transform module 123.

The pattern layer generation module 122 may receive the temporary pattern layer TPL and may generate an extension box EBX and a pattern layer PLYR.

In various example embodiments, the extension box EBX may be a separate layer having the same size as the temporary pattern layer TPL and encompassing the pattern group. As an example, the extension box EBX may be or may include a polygon box layer having the same size and shape as the modification region, but is not limited thereto.

For example, when the shape of the modification region and the temporary pattern layer TPL is a polygon, the extension box EBX may be a polygonal extension box EBX having vertices corresponding to the vertices of the temporary pattern layer TPL. As an example, the coordinates of the vertices of the extension box EBX may be the same as the coordinates of the vertices of the temporary pattern layer TPL. As an example, the extension box EBX may be a separate layer having the same size as the temporary pattern layer TPL and in which the pattern is not scripted. The extension box EBX generated by the pattern layer generation module 122 may be provided to the transform module 123.

The pattern layer generation module 122 may generate the extension box EBX and the pattern layer PLYR using the temporary pattern layer TPL received from the extracting module 121. In various example embodiments, the pattern layer PLYR may be generated by placing the temporary pattern layer TPL on the extension box EBX and then removing a region overlapping the temporary pattern layer TPL.

In various example embodiments, the pattern layer generation module 122 may perform an inverting operation of overlapping the temporary pattern layer TPL on the extension box EBX and then inverting, or negating the pattern. A region overlapping the pattern group scripted in the embossed temporary pattern layer TPL in the extension box EBX may be removed by the inverting operation. Accordingly, the pattern group may be scripted in indenting in the extension box EBX to generate the pattern layer PLYR. The pattern layer PLYR generated by the pattern layer generation module 122 may be provided to the transform module 123.

The transform module 123 may receive the extension box EBX, the pattern layer PLYR, the background layer LayB, and a second transform information TD2 to generate the final layout graphic LayO.

The second transform information TD2 may include information for designating transform regions in which the pattern layer PLYR is to be placed. In various example embodiments, the second transform information TD2 may include information on coordinates of transform regions in which the pattern layer PLYR is to be placed on the background layer LayB. The transform regions may be or may include regions in which the modification regions are coordinate-transformed in the temporary layout LayG. The transform module may designate transform regions on the background layer LayB based on the second transform information TD2.

The transform module 123 may perform a placing operation of placing the pattern layer PLYR on transform regions of the background layer LayB. The placing operation may include an operation of copying the pattern layer PLYR and repeatedly pasting the copied pattern layer on the transform regions. The transform module 123 may place the pattern layers PLYR on the transform regions of the background layer LayB, and then may output them as the final layout graphic LayO.

In various example embodiments, the transform module 123 may perform a transform region removal operation that removes transform regions of the background layer LayB. The transform region removal operation may include an operation of placing the extension box EBX on the transform regions and then removing a region overlapping the extension box EBX. The transform region removal operation may be performed before placing the pattern layer PLYR on the transform regions.

According to various example embodiments, the extraction operation for extracting the pattern group may be performed only once in transforming the coordinates of the modification regions including the same pattern group. Thereafter, a pattern layer is generated using an extracted pattern group PTG and the pattern layer is placed on the transform regions, thereby obtaining the effect that the pattern groups inside the modification regions are coordinate-transformed onto the transform regions.

According to some example embodiments, since the extraction operation for extracting the pattern group is performed only once in the modification operation for the temporary layout, the amount of calculation performed during the modification operation may be reduced. Alternatively or additionally, the time required for the modification operation may be reduced, compared to the case of performing an extraction operation of extracting a pattern group on all modification regions.

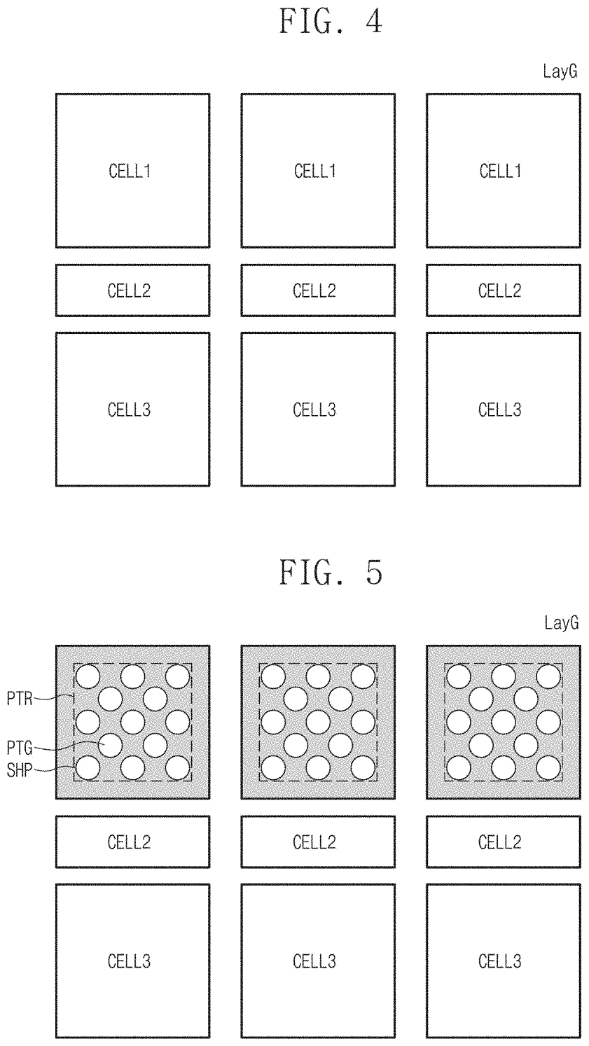

FIGS. 4 and 5 are diagrams illustrating an example of a temporary layout provided to the extracting module 121 in FIG. 3. Hereinafter, designation of modification regions PTR on the temporary layout LayG based on the first transform information TD1 by the extracting module 121 will be described in detail with reference to FIGS. 3, 4 and 5.

Referring to FIGS. 3, 4, and 5, the extracting module 121 may receive the temporary layout LayG and the first transform information TD1. The temporary layout LayG may include a plurality of hierarchical layers.

The extracting module 121 may designate a layer to be modified in the temporary layout LayG based on information on the modification target layer among the first transform information TD1. In various example embodiments, FIG. 4 may indicate any one layer of the temporary layout LayG designated based on the modification target layer information. Hereinafter, the temporary layout LayG may refer to a layer of layer designated based on the modification target layer information.

The temporary layout LayG may include the plurality of cell regions CELL1, CELL2, and CELL3 and peripheral circuit regions (not illustrated). For example, the temporary layout LayG may include the first to third cell regions CELL1, CELL2, and CELL3. The first cell regions CELL1, the second cell regions CELL2, and the third cell regions CELL3 may be arranged to be spaced apart from each other. The plurality of cell regions CELL1, CELL2, and CELL3 may be regions of a memory device, such as a DRAM device and/or a FLASH device; however, example embodiments are not limited thereto.

The temporary layout LayG may include a pattern scripted in indenting on the cell regions CELL1, CELL2, and CELL3. The shape of the pattern scripted in each cell region may be the same, but is not limited thereto.

For example, the first cell regions CELL1 may include a pattern scripted in indenting, and the first cell regions CELL1 may include the same pattern. For example, the second cell regions CELL2 may include a pattern scripted in embossing, and the second cell regions CELL2 may include the same pattern. As in the above description, patterns scripted in the third cell regions CELL3 may also have the same shape, e.g. as that of the first cell regions CELL1.

The extracting module 121 may designate a cell region to be modified in the temporary layout LayG based on information on the modification target cell region. For example, the first cell regions CELL1 on the temporary layout LayG may be designated as the modification target cell regions.

The extracting module 121 may designate the modification regions PTR in the modification target cell regions based on the information of the modification target region. The modification regions PTR may include pattern groups PTG having the same shape. Each modification region PTR may be a region encompassing the pattern group PTG. For example, the modification region PTR may be a rectangular region encompassing the pattern groups PTG.

Each of the pattern groups PTG may include a plurality of shapes SHP, and the shapes SHP constituting or included in the pattern group PTG in each of the modification regions PTR may have the same shape and/or the same arrangement as each other. For example, the pattern group PTG may include a plurality of regularly arranged shapes SHP, but example embodiments are not limited thereto.

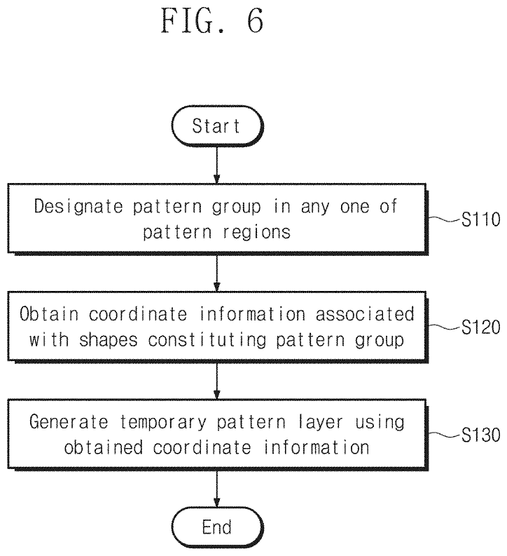

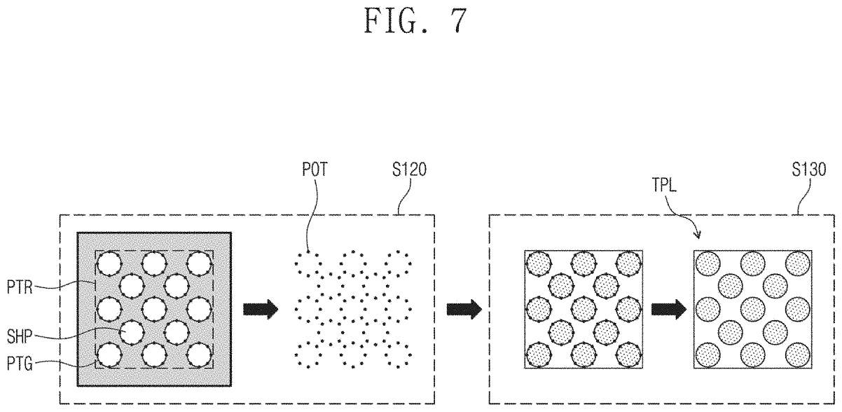

FIG. 6 is a flowchart illustrating that an extracting module of FIG. 3 generates a temporary pattern layer by extracting a pattern group from a temporary layout. FIG. 7 is a diagram for describing an operation of an extracting module corresponding to FIG. 6. Hereinafter, with reference to FIGS. 3, 6 and 7, it will be described in detail that the extracting module 121 extracts the pattern group PTG to generate the temporary pattern layer TPL.

Referring to FIGS. 3, 6 and 7, in operation S110, the extracting module 121 may designate the pattern group PTG included in any one or more of the modification regions PTR on the temporary layout LayG.

In operation S120, the extracting module 121 may perform an operation of obtaining coordinate information associated with the pattern group PTG. In various example embodiments, obtaining the coordinate information associated with the pattern group PTG may include obtaining the coordinate information of the shapes SHP constituting the pattern group PTG. For example, the coordinate information of the shapes SHP may include coordinate information of a plurality of points POT on edges of the shapes SHP.

For example, when the shape SHP is a polygon (not illustrated), coordinates of points corresponding to vertices of the polygon shape SHP may be obtained. As another example, when the shape SHP is circular, the number of a plurality of points POT from which coordinate information is to be obtained on an edge of the shape SHP may be separately set. As a non-limiting example, the number of the plurality of points POT may be set to eight. Accordingly, coordinates of eight points POT on the edge of each shape SHP may be obtained. When the shape of the shape SHP is circular, as the number of points POT is set to be larger, the shape of the shape SHP may be more accurately extracted.

In operation S130, the extracting module 121 may generate the temporary pattern layer TPL in which the pattern group PTG is scripted based on the obtained coordinate information of the pattern group PTG.

A size of the temporary pattern layer TPL may be set to be the same as a size of the modification region PTR. As an example, the temporary pattern layer TPL may be set to have the same vertex coordinates as the vertex coordinates of the modification region PTR.

In various example embodiments, generating the temporary pattern layer TPL may include connecting points corresponding to the shapes SHP included in the pattern group PTG obtained in operation S120 to restore the shapes SHP. Accordingly, the temporary pattern layer TPL in which the pattern group PTG is scripted in embossing may be generated. According to some examples, in the temporary pattern layer TPL, the pattern group PTG may be scripted in embossing and a region excluding the pattern group PTG may be empty.

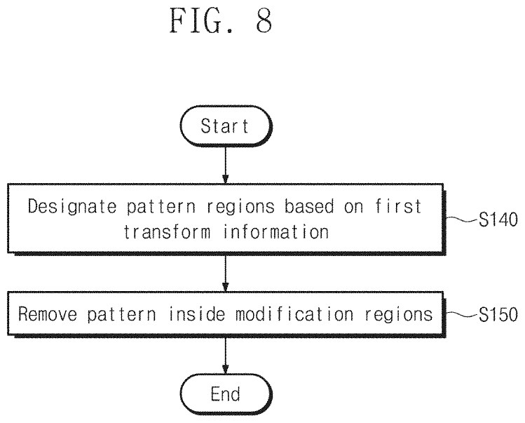

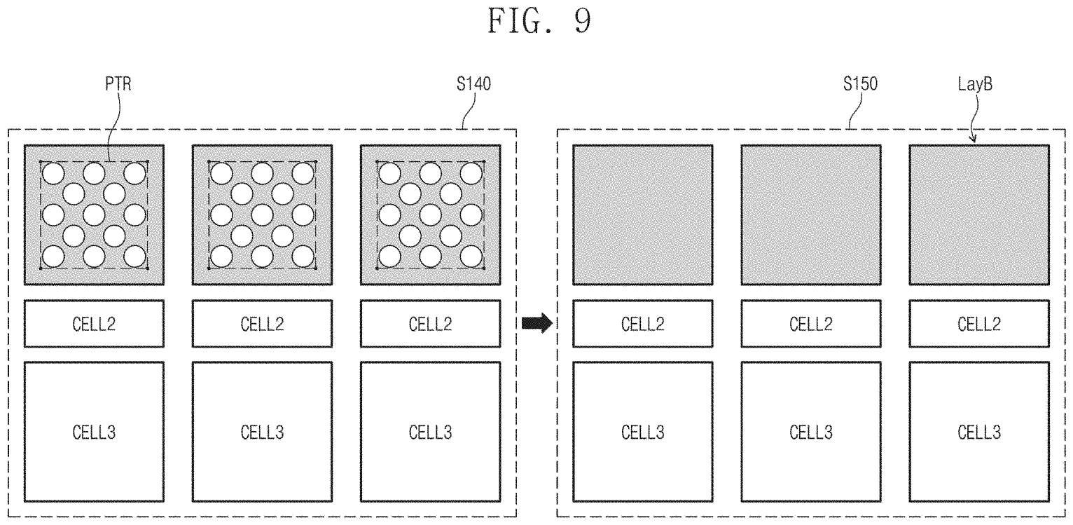

FIG. 8 is a flowchart for describing that an extracting module of FIG. 3 generates a background layer. FIG. 9 is a diagram for describing an operation of an extracting module corresponding to FIG. 8. Hereinafter, with reference to FIGS. 3, 8 and 9, it will be described in detail that the extracting module 121 generates the background layer LayB.

Referring to FIGS. 3, 8, and 9, in operation S140, the extracting module 121 may designate the modification regions PTR on the temporary layout based on the first transform information TD1. The pattern groups PTG included in the modification regions PTR may all have the same shape.

In operation S150, a pattern removal operation of removing a pattern inside the modification regions PTR of the first cell regions CELL1 may be performed. The pattern groups PTG in the modification regions PTR may be removed through the pattern removal operation.

The extracting module 121 may generate the background layer LayB by removing the pattern inside the modification regions PTR on the temporary layout LayG through operations S140 and S150. In the background layer LayB generated by the extracting module 121, a pattern may not exist in the modification regions PTR. The background layer LayB generated by the extracting module 121 may be provided to the transform module 123.

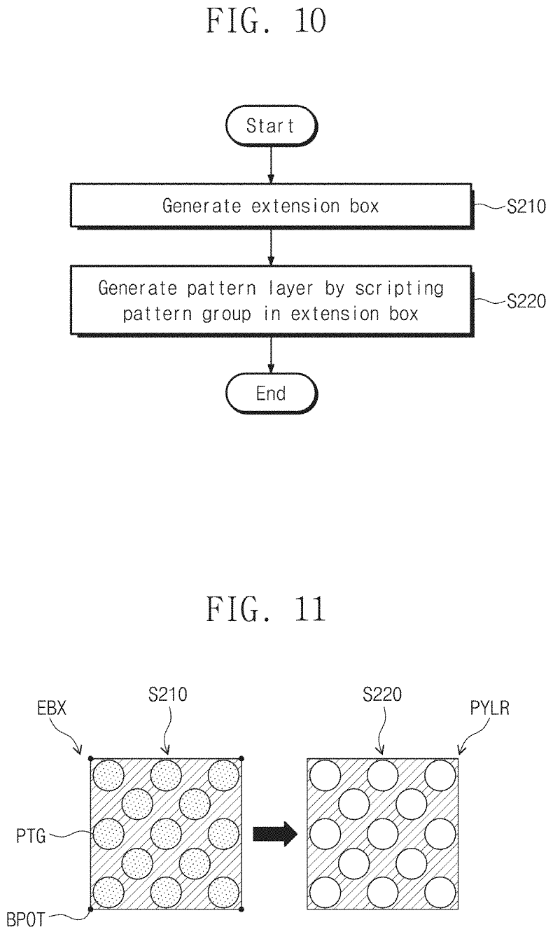

FIG. 10 is a flowchart illustrating that a pattern layer generation module of FIG. 3 generates an extension box and a pattern layer. FIG. 11 is a diagram for describing an operation of the pattern layer generation module corresponding to FIG. 10. Hereinafter, with reference to FIGS. 3, 10, and 11, it will be described in detail that the pattern layer generation module 122 generates the extension box EBX and the pattern layer PLYR.

Referring to FIGS. 3, 10 and 11, in operation S210, the pattern layer generation module 122 may generate the extension box EBX including the pattern group PTG of the temporary pattern layer TPL. Generating the extension box EBX may include, for example, extracting coordinates for vertices BPOT of the temporary pattern layer TPL to generate a separate layer having the same vertex. Accordingly, the extension box EBX may have the same size as the temporary pattern layer TPL and the modification region PTR. The extension box EBX obtained in operation S210 may be provided to the transform module 123.

In operation S220, the pattern layer generation module 122 may generate the pattern layer PLYR by scripting the pattern group PTG in the extension box EBX. In various example embodiments, the pattern layer generation module 122 may generate the pattern layer PLYR by scripting the pattern group PTG in indenting in the extension box EBX.

For example, the pattern layer generation module 122 may place the temporary pattern layer TPL on the extension box EBX such that the vertices BPOT of the temporary pattern layer TPL coincide with the vertices of the extension box EBX, and then may perform the inverting operation to remove a region overlapping the pattern group PTG of the temporary pattern layer TPL in the extension box EBX. The pattern layer PLYR generated in operation S220 may be provided to the transform module 123.

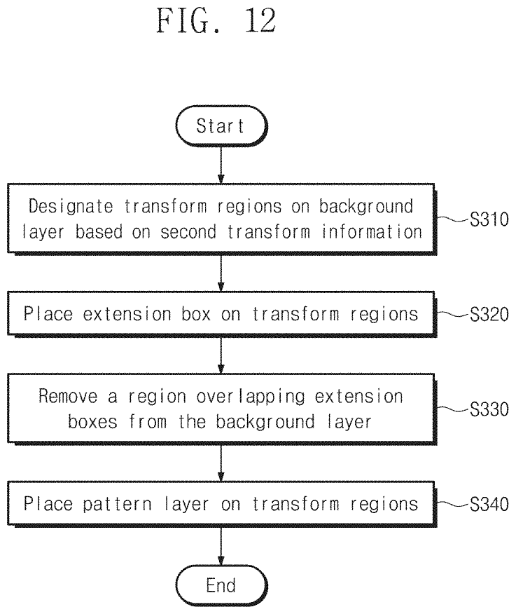

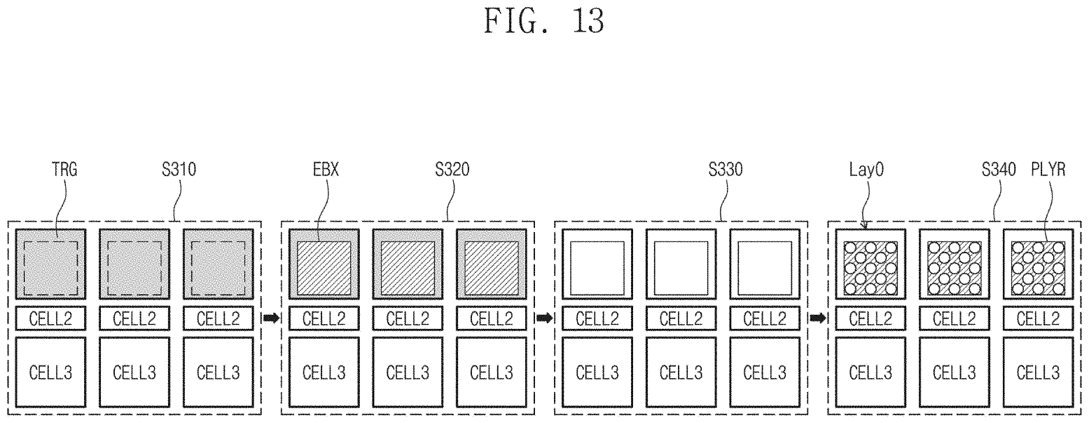

FIG. 12 is a flowchart for describing that a transform module of FIG. 3 generates a final layout graphic. FIG. 13 is a diagram for describing an operation of a transform module corresponding to FIG. 12. Hereinafter, with reference to FIGS. 3, 12 and 13, it will be described in detail that the transform module 123 generates the final layout graphic LayO.

Referring to FIGS. 12 and 13, in operation S310, the transform module 123 may designate the transform regions TRG on the background layer LayB received from the extracting module 121, based on the second transform information TD2 received from the control module 130.

The second transform information TD2 may include information on position coordinates of the transform regions TRG. For example, the second transform information TD2 may include coordinate information associated with vertices of each of the transform regions TRG.

In various example embodiments, the transform regions TRG may be or may include regions in which the pattern layer PLYR is to be placed on the first cell regions CELLE For example, the transform regions TRG may be or may include regions in which the patterns inside the modification regions PTR are coordinate-transformed and placed on the temporary layout LayG. The positions of the transform regions TRG may be the same as or different from each other on the corresponding first cell regions CELLE A size and shape of each of the transform regions TRG may be the same as the size and shape of the extension box EBX and the pattern layer PLYR.

The transform regions TRG may be target regions to which the modification input MI intends to transform the coordinates of the pattern inside the modification regions PTR. For example, the transform regions may be obtained by moving the modification regions of the first cell regions CELL1 of the temporary layout LayG in parallel by a predetermined distance in a direction toward the second cell regions CELL2.

In operation S320, the transform module 123 may perform the placing operation of placing the extension box EBX received from the pattern layer generation module 122 on the transform regions TRG of the background layer LayB. The placing of the extension box EBX may include repeatedly performing an operation of copying the extension box EBX and pasting the copied extension box EBX on the transform regions TRG. As a non-limiting example, the extension boxes EBX may be placed such that the vertices of each of the transform regions TRG and the vertices of the extension box EBX overlap each other.

In operation S330, the transform module 123 may perform a removal operation of removing a region overlapping the extension box EBX from the background layer LayB. For example, an inverting operation of inverting the extension boxes EBX placed on the transform regions TRG in the background layer LayB may be performed. Accordingly, the transform regions TRG may be removed from the background layer LayB to be engraved.

In operation S340, the transform module may perform the placing operation of placing the pattern layer PLYR received from the pattern layer generation module 122 on the transform regions TRG of the background layer LayB. The placing operation of the pattern layer PLYR may include repeatedly performing an operation of copying the pattern layer PLYR and pasting the copied pattern layer PLYR on the transform regions TRG. For example, the pattern layers PLYR may be placed such that the vertices of each of the transform regions TRG and the vertices of the pattern layer PLYR overlap each other.

The transform module 123 may output a state in which the pattern layer PLYR is placed on the transform regions TRG of the background layer LayB as the final layout graphic LayO. Accordingly, the final layout graphic LayO may include the plurality of pattern layers PLYR placed on the background layer LayB and the transform regions TRG. The final layout graphic LayO output from the transform module 123 may be provided to the semiconductor fabrication device 200 (refer to FIG. 1).

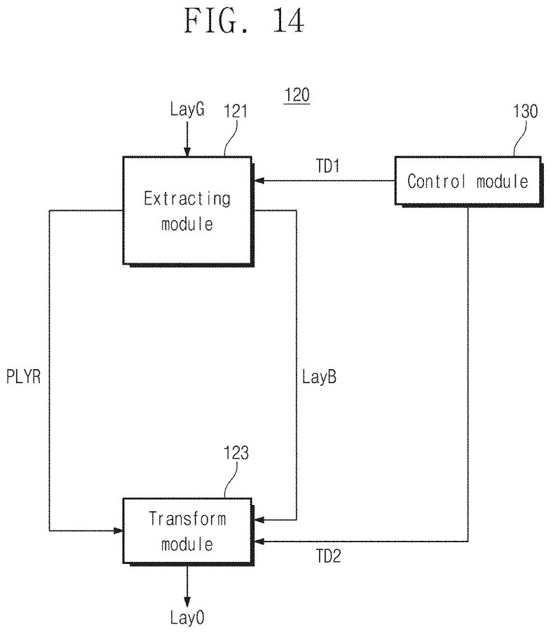

FIG. 14 is a block diagram illustrating another embodiment of a layout modifying module of FIG. 2. Hereinafter, various example embodiments of the layout modifying module 120 will be described in detail with reference to FIG. 14.

Referring to FIG. 14, the layout modifying module 120 may include the extracting module 121 and the transform module 123. In various example embodiments, the layout modifying module 120 may modify the temporary layout LayG in which the embossed pattern is scripted based on the transform information TD to generate the final layout graphic LayO.

In various example embodiments, the extracting module 121 may generate the pattern layer PLYR and the background layer LayB. The pattern layer PLYR and the background layer LayB generated by the extracting module 121 may be provided to the transform module 123.

The extracting module 121 may receive the temporary layout LayG and first transform information TD1. The received temporary layout LayG may include a plurality of hierarchical layers. As an example, any one of the received plurality of layers may include a pattern, which is scripted in embossing. As in FIG. 3, the first transform information TD1 may include information for designating a modification target layer, a modification target cell region, and a modification target region of the temporary layout LayG.

In various example embodiments, the extracting module 121 may designate one layer to be modified among a plurality of hierarchical layers of the temporary layout LayG based on the information on the modification target layer of the first transform information TD1. The extracting module 121 may designate a cell region to be modified among cell regions on a designated layer based on the information on the modification target cell region of the first transform information TD1. The extracting module 121 may designate modification regions to be modified in a designated cell region on a designated layer based on the information on the modification target region of the first transform information TD1.

The modification regions designated based on the first transform information TD1 may include pattern groups having the same shape. The pattern group may refer to a pattern included in the modification regions. Each of the pattern groups may include a plurality of shapes, and shapes constituting the pattern group in each of the modification regions may have the same shape and arrangement as each other.

The extracting module 121 may perform an extraction operation of extracting a pattern group from any one of the designated modification regions based on the first transform information TD1. The extracting module 121 may generate the pattern layer PLYR by using the pattern group extracted through the extraction operation.

In various example embodiments, the pattern layer PLYR generated by the extracting module 121 may be a separate layer including the extracted pattern group. As an example, the pattern layer PLYR may be a layer in which the pattern group is scripted in embossing.

A size of the pattern layer PLYR may be set to be the same as a size of the modification region. As an example, the size of the pattern layer PLYR may be set to have the same vertex coordinates as the vertex coordinates of the modification region. The pattern layer PLYR generated by the extracting module 121 may be provided to the transform module 123.

The extracting module 121 may generate the background layer LayB. The background layer LayB may be a layer from which patterns inside the modification regions are removed in the temporary layout LayG. The background layer LayB generated by the extracting module 121 may be provided to the transform module 123.

The transform module 123 may receive the pattern layer PLYR, the background layer LayB, and the second transform information TD2 to generate the final layout graphic LayO.

The second transform information TD2 may include information for designating transform regions in which the pattern layer PLYR is to be placed. In various example embodiments, the second transform information TD2 may include information on coordinates of transform regions in which the pattern layer PLYR is to be placed on the background layer LayB. The transform regions may be regions in which the modification regions are coordinate-transformed in the temporary layout LayG. The transform module may designate transform regions on the background layer LayB based on the second transform information TD2.

The transform module 123 may perform the placing operation of placing the pattern layer PLYR on transform regions of the background layer LayB. The placing operation may include an operation of copying the pattern layer PLYR and repeatedly pasting the copied pattern layer on the transform regions. The transform module 123 may place the pattern layers PLYR on the transform regions of the background layer LayB, and then may output them as the final layout graphic LayO.

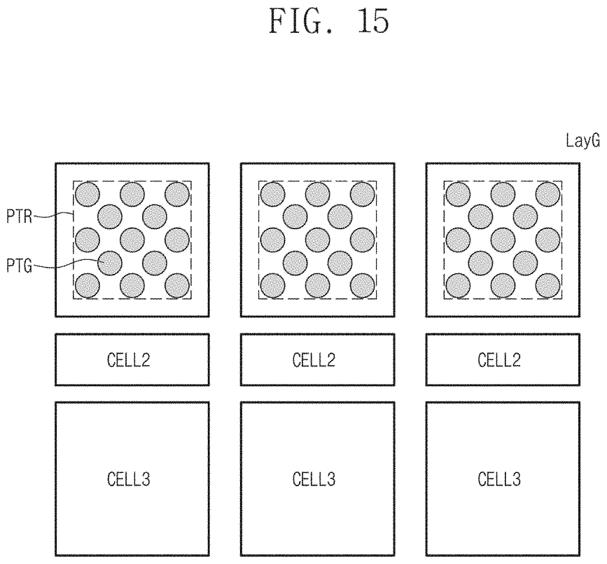

FIG. 15 is a diagram illustrating an example of a temporary layout provided to an extracting module in FIG. 14. Hereinafter, with reference to FIGS. 14 and 15, it will be described in detail that the extracting module 121 designates the modification regions PTR on the temporary layout LayG of the modification target layer based on the first transform information TD1.

Referring to FIGS. 14 and 15, the extracting module 121 may receive the temporary layout LayG and the first transform information TD1. The received temporary layout LayG may include a plurality of hierarchical layers.

The extracting module 121 may designate a layer to be modified in the temporary layout LayG based on information on the modification target layer among the first transform information TD1. In various example embodiments, FIG. 15 may indicate any one layer of the temporary layout LayG designated based on the modification target layer information. Hereinafter, the temporary layout LayG may refer to a layer of layer designated based on the modification target layer information.

The temporary layout LayG may include the plurality of cell regions CELL1, CELL2, and CELL3 and peripheral circuit regions (not illustrated). For example, the temporary layout LayG may include the first to third cell regions CELL1, CELL2, and CELL3. The first cell regions CELL1, the second cell regions CELL2, and the third cell regions CELL3 may be arranged to be spaced apart from each other.

In various example embodiments, the temporary layout LayG may include a scripted pattern in embossing on the cell regions. The shape of the pattern scripted in each cell region may be the same, but is not limited thereto.

The extracting module 121 may designate a cell region to be modified in the temporary layout LayG based on information on the modification target cell region. For example, the first cell regions CELL1 on the temporary layout LayG may be designated as the modification target cell regions.

The extracting module 121 may designate the modification regions PTR in the modification target cell regions based on the information on the modification target region. The modification regions PTR may include pattern groups PTG having the same shape. Each modification region PTR may be a region encompassing the pattern group PTG. For example, the modification region PTR may be a rectangular region encompassing the pattern groups PTG.

Each of the pattern groups PTG may include a plurality of shapes SHP, and the shapes SHP constituting the pattern group PTG in each of the modification regions PTR may have the same shape and arrangement as each other. For example, the pattern group PTG may include a plurality of regularly arranged shapes SHP, but is not limited thereto.

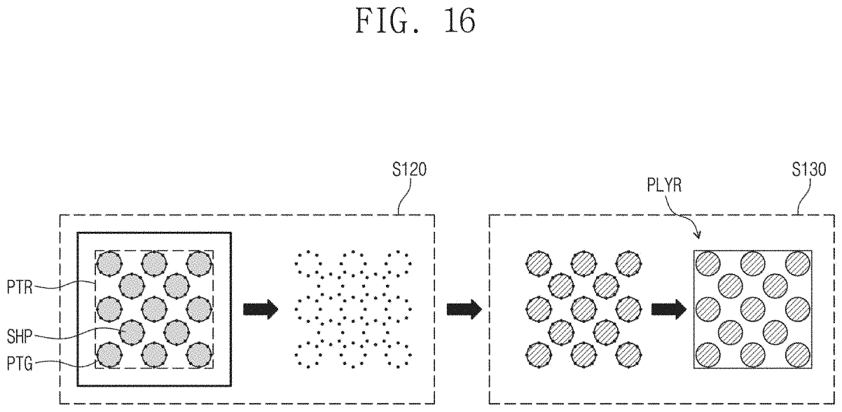

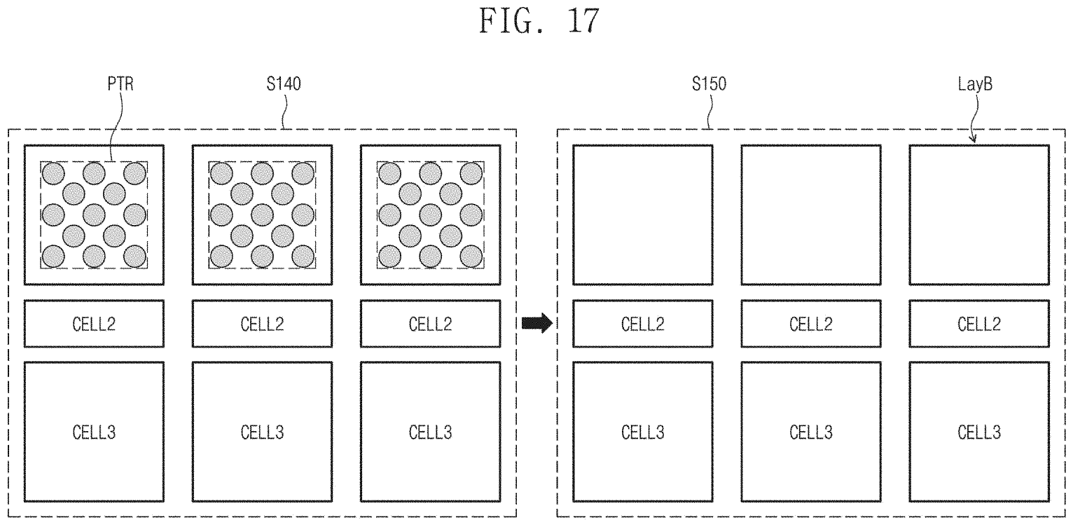

FIG. 16 is a diagram for describing an operation of generating a pattern layer of the extracting module. In various example embodiments, the extracting module 121 may be operated according to the same flow as described in the flowchart of FIG. 6. Hereinafter, with reference to FIGS. 6 and 16, it will be described in detail that the extracting module 121 extracts the pattern group PTG to generate the pattern layer PLYR.

Referring to FIGS. 6, 14, and 16, in operation S110, the extracting module 121 may designate the pattern group PTG included in any one of the modification regions PTR on the temporary layout LayG.

In operation S120, the extracting module 121 may perform an operation of obtaining coordinate information associated with the pattern group PTG. In various example embodiments, obtaining the coordinate information associated with the pattern group PTG may include obtaining the coordinate information of the shapes SHP constituting the pattern group PTG. For example, the coordinate information of the shapes SHP may include coordinate information of a plurality of points POT on edges of the shapes SHP.

In operation S130, the extracting module 121 may generate the pattern layer PLYR in which the pattern group PTG is scripted based on the obtained coordinate information of the pattern group PTG.

A size of the pattern layer PLYR may be set to be the same as a size of the modification region PTR. As an example, the pattern layer PLYR may be set to have the same vertex coordinates as the vertex coordinates of the modification region PTR.

In various example embodiments, generating of the pattern layer PLYR may include connecting points corresponding to the shapes SHP constituting the pattern group PTG obtained in operation S120 to restore the shapes SHP. Accordingly, the pattern layer PLYR in which the pattern group PTG is scripted in embossing may be generated. In other words, in the pattern layer PLYR, the pattern group PTG may be scripted in embossing and a region excluding the pattern group PTG may be empty.

FIG. 17 is a diagram for describing an operation of generating a background layer of an extracting module. In various example embodiments, the extracting module 121 may be operated according to the same flow as described in the flowchart of FIG. 8. Hereinafter, with reference to FIGS. 8, 14, and 17, it will be described in detail that the extracting module 121 generates the background layer LayB.

Referring to FIGS. 8, 14, and 17, the extracting module 121 may designate the modification regions PTR on the temporary layout based on the first transform information TD1. The pattern groups PTG included in the modification regions PTR may all have the same shape.

In operation S150, a pattern removal operation of removing a pattern inside the modification regions PTR of the first cell regions CELL1 may be performed. The pattern groups PTG in the modification regions PTR may be removed through the pattern removal operation.

The extracting module 121 may generate the background layer LayB by removing the pattern inside the modification regions PTR on the temporary layout LayG through operations S140 and S150. In the background layer LayB generated by the extracting module 121, a pattern may not exist in the modification regions PTR. The background layer LayB generated by the extracting module 121 may be provided to the transform module 123.

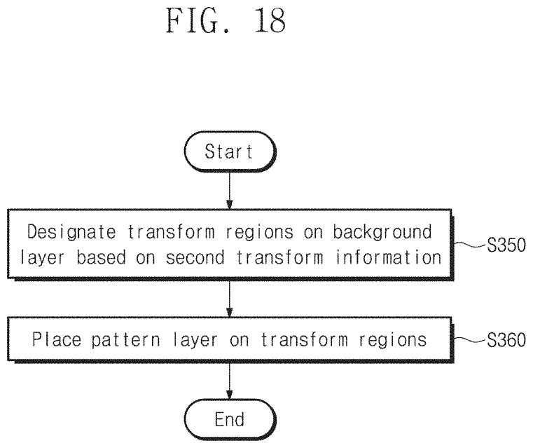

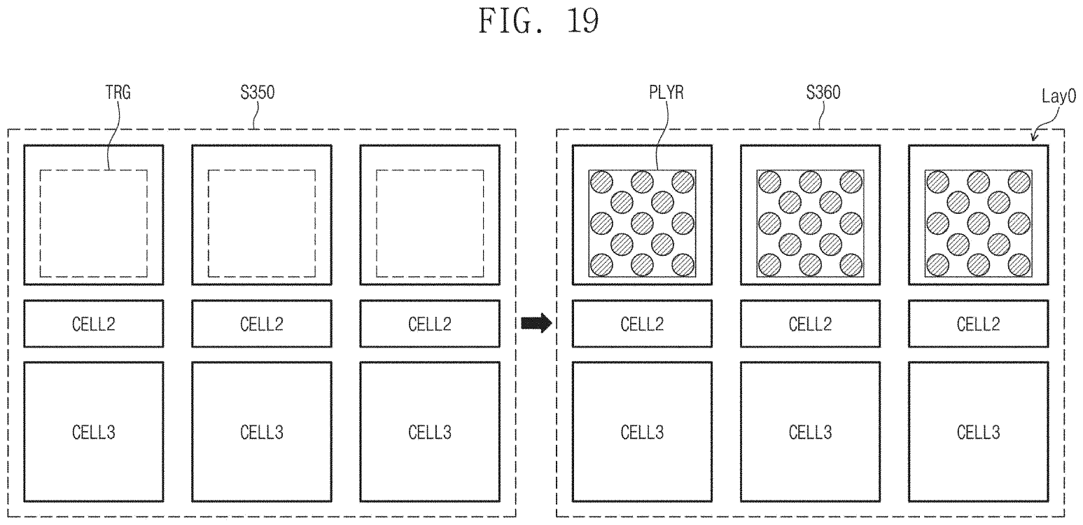

FIG. 18 is a flowchart for describing that a transform module of FIG. 14 generates a final layout graphic. FIG. 19 is a diagram for describing an operation of a transform module corresponding to FIG. 18. Hereinafter, with reference to FIGS. 14, 18, and 19, it will be described in detail that the transform module 123 generates the final layout graphic LayO.

Referring to FIGS. 18 and 19, in operation S350, the transform module 123 may designate the transform regions TRG on the background layer LayB received from the extracting module 121, based on the second transform information TD2 received from the control module 130.

In various example embodiments, the transform regions TRG may be regions in which the pattern layer PLYR is to be placed on the first cell regions CELL1. That is, the transform regions TRG may be regions in which the patterns inside the modification regions PTR are coordinate-transformed and placed on the temporary layout LayG. The positions of the transform regions TRG may be the same as or different from each other on the corresponding first cell regions CELL1. A size and shape of each of the transform regions TRG may be the same as the size and shape of the extension box EBX and the pattern layer PLYR.

The transform regions TRG may be target regions to which the modification input MI intends to transform the coordinates of the pattern inside the modification regions PTR. For example, the transform regions may be obtained by moving the modification regions of the first cell regions CELL1 of the temporary layout LayG in parallel by a predetermined distance in a direction toward the second cell regions CELL2.

In operation S360, the transform module may perform the placing operation of placing the pattern layer PLYR received from the pattern layer generation module 122 on the transform regions TRG of the background layer LayB. The placing operation of the pattern layer PLYR may include repeatedly performing an operation of copying the pattern layer PLYR and pasting the copied pattern layer PLYR on the transform regions TRG. For example, the pattern layers PLYR may be placed such that the vertices of each of the transform regions TRG and the vertices of the pattern layer PLYR overlap each other.

The transform module 123 may output a state in which the pattern layer PLYR is placed on the transform regions TRG of the background layer LayB as the final layout graphic LayO. Accordingly, the final layout graphic LayO may include the plurality of pattern layers PLYR placed on the background layer LayB and the transform regions TRG. The final layout graphic LayO generated by the transform module 123 may be provided to the semiconductor fabrication device 200 (refer to FIG. 1).

According to various example embodiments, a layout modifying module may be provided that performs a modification on modification regions including the same pattern groups with low computation.

According to various example embodiments, a layout modification method may be provided that performs a modification on modification regions including the same pattern groups with low computation.

Any of the elements and/or functional blocks disclosed above may include or be implemented in processing circuitry such as hardware including logic circuits; a hardware/software combination such as a processor executing software; or a combination thereof. For example, the processing circuitry more specifically may include, but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), etc. The processing circuitry may include electrical components such as at least one of transistors, resistors, capacitors, etc. The processing circuitry may include electrical components such as logic gates including at least one of AND gates, OR gates, NAND gates, NOT gates, etc.

The above are various example embodiments for carrying out various aspects of inventive concepts. Embodiments in which a design is changed simply and/or which are easily changed may be included as well as various example embodiments embodiment described above. In addition, technologies that are easily changed and implemented by using the above embodiments may be included in the present disclosure. While inventive concepts has been described with reference to embodiments thereof, it will be apparent to those of ordinary skill in the art that various changes and modifications may be made thereto without departing from the spirit and scope of the present disclosure as set forth in the following claims. Furthermore example embodiments are not necessarily mutually exclusive. For example, some example embodiments may include one or more features described with reference to one or more drawings, and may also include one or more other features described with reference to one or more other drawings.

What is claimed is:

1. A layout design tool configured to generate a layout graphic based on a first input and a modification input, the layout design tool comprising:
processing circuitry configured to execute machine-readable instructions that, when executed by the processing circuitry, cause the processing circuitry,
to generate a temporary layout in which a pattern is scripted based on the first input,
to modify the temporary layout based on the modification input to generate the layout graphic,
to designate a plurality of modification regions to be modified on the temporary layout based on the modification input, and to designate a plurality of transform regions on a background layer, the plurality of modification regions of the temporary layout include pattern groups having a same shape,
to generate a pattern layer by extracting the pattern group included in any one of the plurality of modification regions, and
to generate the layout graphic by placing the pattern layer on the plurality of transform regions of the background layer.

2. The layout design tool of claim 1, wherein the pattern groups are scripted in indenting on the modification regions, and
the processing circuitry is configured
to receive the temporary layout and the modification input and to generate a temporary pattern layer in which the pattern group is scripted in embossing,
to receive the temporary layout and the modification input,
to generate the background layer by removing the pattern groups of the modification regions in the temporary layout,
to receive the temporary pattern layer and to generate the pattern layer in which the pattern group is scripted in indenting,
to receive the pattern layer and the background layer, and
to perform a placing operation of placing the pattern layer on the transform regions of the background layer.

3. The layout design tool of claim 2, wherein processing circuitry is configured to copy the pattern layer and paste the copied pattern layer onto the transform regions to perform the placing operation.

4. The layout design tool of claim 2, wherein the processing circuitry is configured to obtain coordinate information associated with the pattern group, and to generate the temporary pattern layer in which the pattern group is scripted in embossing by using the obtained coordinate information.

5. The layout design tool of claim 4, wherein
a size of the temporary pattern layer is the same as a size of the modification region, and
a size of the pattern layer is the same as a size of the temporary pattern layer.

6. The layout design tool of claim 1, wherein the processing circuitry is configured
to script the pattern groups in embossing on the modification regions,
to receive the temporary layout and the modification input and to generate the pattern layer in which the pattern group is scripted in embossing,
to receive the temporary layout and the modification input and to generate the background layer by removing the pattern groups of the modification regions in the temporary layout,
to receive the pattern layer and the background layer, and
to perform a placing operation of placing the pattern layer on the transform regions of the background layer.

7. The layout design tool of claim 6, wherein the processing circuitry is configured to copy the pattern layer and paste the copied pattern layer onto the transform regions to perform the placing operation.

8. The layout design tool of claim 6, wherein the processing circuitry is configured to obtain coordinate information associated with the pattern group, and to generate the pattern layer in which the pattern group is scripted in embossing by using the obtained coordinate information.

9. The layout design tool of claim 8, wherein a size of the pattern layer is a same as a size of the modification region.

10. The layout design tool of claim 1, wherein each of the pattern groups includes a plurality of shapes.

11. A method of modifying a layout, the method comprising:
designating a plurality of modification regions, which include pattern groups having a same shape, to be modified on a temporary layout;
generating a pattern layer by extracting the pattern group from any one of the plurality of modification regions;
generating a background layer by removing the pattern groups within the plurality of modification regions in the temporary layout;
designating transform regions on the background layer; and
placing the pattern layer on the transform regions of the background layer to generate a final layout graphic.

12. The method of claim 11, wherein,
each of the pattern groups includes a plurality of shapes,
a shape of the plurality of shapes that are included in the pattern groups included in the modification regions are a same as each other, and
an arrangement of the plurality of shapes that are included in the pattern groups included in the modification regions are a same as each other.

13. The method of claim 12, wherein the generating of the pattern layer includes:
obtaining coordinate information associated with the plurality of shapes included in the pattern groups, and
generating the pattern layer in which the pattern group is scripted in embossing by using the obtained coordinate information.

14. The method of claim 13, wherein the obtaining of the coordinate information associated with the plurality of shapes includes obtaining coordinate information of a plurality of points on edges of the plurality of shapes.

15. The method of claim 11, wherein the placing of the pattern layer on the transform regions includes:
performing operations of copying the pattern layer and pasting the copied pattern layer onto the transform regions.

16. The method of claim 11, wherein
a size of the pattern layer is a same as a size of the modification region, and
a size of the transform region is a same as a size of the pattern layer.

17. The method of claim 11, wherein
the pattern groups are scripted in indenting on the modification regions, and
the pattern layer includes the pattern group scripted in indenting.

18. The method of claim 11, wherein
the pattern groups are scripted in embossing on the modification regions, and
the pattern layer includes the pattern group scripted in embossing.

19. A semiconductor fabrication system for fabricating a semiconductor device by generating a layout graphic based on a first input and a modification input, the semiconductor fabrication system comprising:
a layout design tool configured to generate the layout graphic based on the first input and the modification input; and
a semiconductor fabrication device configured to fabricate the semiconductor device based on the layout graphic,
wherein the layout tool design is configured to execute machine-readable instructions that, when executed, cause the layout generating tool,
to generate a temporary layout in which a pattern is scripted based on the first input,
to modify the temporary layout based on the modification input to generate the layout graphic,
to designate a plurality of modification regions to be modified on the temporary layout based on the modification input, and to designate a plurality of transform regions on a background layer, wherein the plurality of modification regions of the temporary layout include pattern groups having a same shape,
to generate a pattern layer by extracting the pattern group included in any one of the plurality of modification regions, and
to generate the layout graphic by placing the pattern layer on the plurality of transform regions of the background layer.

20. The semiconductor fabrication system of claim 19, wherein the layout design tool is configured to copy the pattern layer and paste the copied pattern layer onto the transform regions to generate the layout graphic.
